(19) United States
(12) Patent Application Publication
(10) Pub. No.: US 2007/0060198 A1
(43) Pub. Date: Mar. 15, 2007

(54) Structure for housing a SIM card and a flash memory card

(75) Inventor: Chung-Hua Kuo, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/082,820

(22) Filed: Mar. 18, 2005

(51) Int. Cl. H04B 1/38; H04M 1/00

(52) U.S. Cl. 455/558; 455/575.1

(57) ABSTRACT

A housing structure located in an electronic communication device to hold a SIM card and a flash memory card includes a SIM card holding bracket and a flash memory card holding bracket. The SIM card holding bracket has two elastic clips on two opposite sides thereof to clamp and hold the SIM card and make electric contacts of the SIM card to face outward to be in contact with the electronic communication device to establish electric connection. The SIM card holding bracket has an inner side in contact with one lateral surface of the flash memory card holding bracket which has an opening on one side to receive the flash memory card into the housing structure to establish electric connection with the electronic communication device.

### BACKGROUND OF THE INVENTION

(1) Field of the Invention

The invention relates to a structure for housing a SIM card and a flash memory card and particularly to a structure for use on an electronic communication device to house a SIM card and a flash memory card.

(2) Description of the Prior Art

Mobile electronic communication devices such as mobile phones have gradually become the mainstream of communication tools for people. A mobile phone such as a GSM mobile phone requires a SIM (Subscriber Identify Module) card to identify the corresponding number of the mobile phone to provide services. SIM card is a plastic card embedded with a chip to store data related to the number.

With constant improvements of the wireless communication bandwidth and advanced data compression techniques, requirements for transmitting video and audio multimedia data also grow. Hence mobile phones equipped with multimedia processing function have been developed and introduced. As the video and audio data are huge and take a great amount of memory, the storing data have to be updated frequently to handle the fast changing multimedia data. To cope this characteristic, flash memory cards are the best choice to store the multimedia data on the market. The commonly used flash cards include Compact Flash Card (CF card), SM Flash Card, Memory Stick (MS card), Multimedia Card (MMC card), Secure Digital (SD card), etc.

To make the mobile phone portable and easy to carry, the hardware design mainly focuses on slim and light. In the conventional techniques, the mobile phone generally has two different structures to hold a SIM card and a flash memory card to establish electric connection with the mobile phone. These two separate structures take a large space and make the mobile phone bulky and heavy. Such a design also impairs design flexibility of other elements and structure of the mobile phone.

Therefore the present invention aims to provide a structure to simultaneously house a SIM card and a flash memory card to solve the aforesaid problems.

### SUMMARY OF THE INVENTION

It is an object of the invention to provide a housing structure to simultaneously house a SIM card and a flash memory card to save space in an electronic communication device for positioning and establishing electric connection.

The housing structure according to the invention is used on an electronic communication device. The housing structure has two opposite lateral sides mating and coupling with two opposing guiding channels of the electronic communication device for loading and unloading the housing structure in the electronic communication device. The housing structure includes a SIM card holding bracket and a flash memory card holding bracket. They are made from the same material and may be fabricated in an integrated manner.

The SIM card holding bracket has two elastic clips on two opposite sides to hold the SIM card and make the electric contacts thereof facing an outer side of the housing structure to establish electric connection with the electronic communication device.

The SIM card bracket has an inner side in contact with one lateral surface of the flash memory card. The flash memory card holding bracket has an opening on one side. After the housing structure is loaded into the electronic communication device, the opening faces the outer side of the electronic communication device to allow a SD card to be inserted into the housing structure to establish electric connection with the electronic communication device.

In addition, the electronic communication device further includes a lifting member located below the housing structure to contact one lateral side of the SIM card bracket. When the housing structure is inserted into the electronic communication device, the lifting structure pushes the SIM card upwards to make electric connection with the electronic communication device.

Thus by adopting the invention on the electronic communication device, a SIM card and a flash memory card may be loaded into the electronic communication device at the same time to save the space of positioning and electric connection. The housing structure of the invention also provides the benefit of carrying the SIM card and the flash memory card at the same time.

### BRIEF DESCRIPTION OF THE DRAWINGS

The present invention will now be specified with reference to its preferred embodiment illustrated in the drawings, in which:

FIG. 1 is a schematic view of the housing structure of the invention used in an electronic communication device;

FIG. 2 is a schematic view of the housing structure for holding a SIM card and a flash memory card;

FIG. 3 is a schematic view of an unloading means of the invention;

FIG. 4 is a sectional view of the lifting member of the invention; and

FIG. 5 is a schematic view of another embodiment of the housing structure of the invention coupled with an electronic communication device.

### DESCRIPTION OF THE PREFERRED EMBODIMENTS

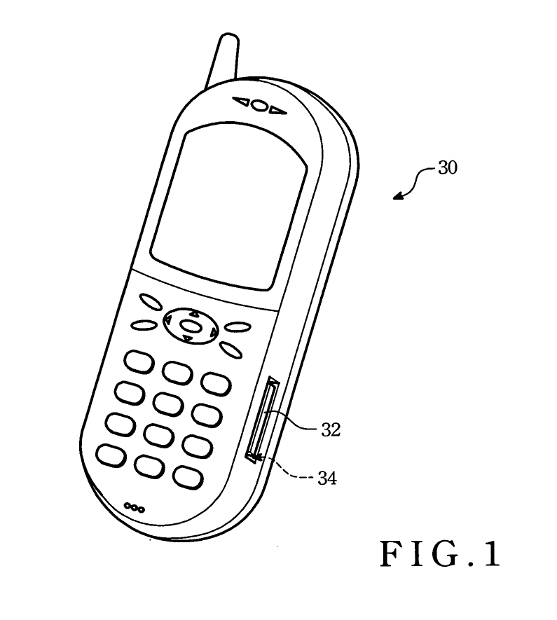

Refer to FIG. 1 for a housing structure 32 coupling with an electronic communication device 30 according to the invention. The electronic communication device 30 such as a mobile phone has an opening 34 on the surface of the case to load the housing structure 32 to establish electric connection of a SIM card and a flash memory card with the electronic communication device 30.

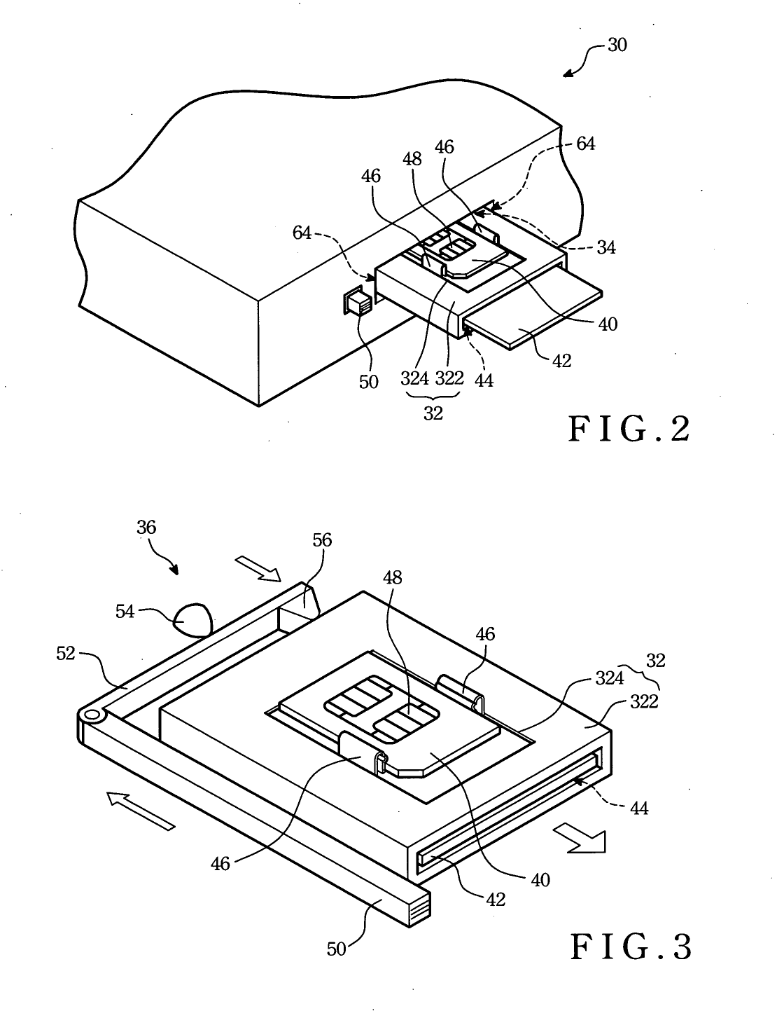

Refer to FIG. 2 for the housing structure 32 to hold a SIM card 40 and a flash memory card 42 in the electronic communication device 30. The housing structure 32 has two opposite sides mating two opposing guiding channels 64 of the electronic communication device 30 to allow the housing structure 32 to be loaded into or unloaded from the electronic communication device 30. The housing structure 32 includes a SIM card holding bracket 324 and a flash memory card holding bracket 322. They may be made from the same material and formed in an integrated manner.

The SIM card holding bracket 324 has two elastic clips 46 on two opposite sides to clamp and hold the loaded SIM card 40 and make electric contacts 48 thereof to face outwards of the housing structure 32. When the housing structure 32 is loaded into the electronic communication device 30, the electric contacts 48 of the SIM card 40 face upwards to connect electrically with the electronic communication device 30.

The flash memory card holding bracket 322 is located below the SIM card holding bracket 324 with one lateral surface in contact with an inner side of the SIM card holding bracket 324. The flash memory card holding bracket 322 has an opening 44 on one side. After housed in the electronic communication device 30, the opening 44 faces outwards of the electronic communication device 30 for loading the flash memory card 42 such as a SD card into the housing structure 32 to connect electrically to the electronic communication device 30.

Refer to FIG. 3 for an unloading means 36 of the invention located in the electronic communication device 30 to unload the housing structure 32. It includes a push rod 50, a linkage bar 52, a fulcrum 54 and an unloading member 56.

The push rod 50 is located on the electronic communication device 30 abutting one side of the housing structure 30 and movable back and forth parallel with the one side of the housing structure. As shown in FIG. 2, the push rod 50 has one end exposed outside the electronic communication device 30 to be depressed by users to unload the housing structure 32.

The linkage bar 52 has one end pivotally coupled with other end of the push rod 50 in an almost vertical manner. The linkage bar 52 is abutting another side of the housing structure 32 opposite to the opening 44 and substantially in parallel therewith.

The fulcrum 54 is fixedly located on the electronic communication device 30 between two ends of the linkage bar 52 to couple the linkage bar 5 on the electronic communication device 30. The unloading member 56 is located on another end of the linkage bar 52 remote from the pivot end. When the housing structure 32 is loaded into the electronic communication device 30, the unloading member 56 is in contact with the another side of the housing structure 32 opposing the opening 44.

Thus when the push rod 50 is moved under an external force towards the electronic communication device 30, the pivot end of the linkage bar 52 receives the force to generate a levering action about the fulcrum 54 to move the unloading member 56 to push the housing structure 32 outside the electronic communication device 30.

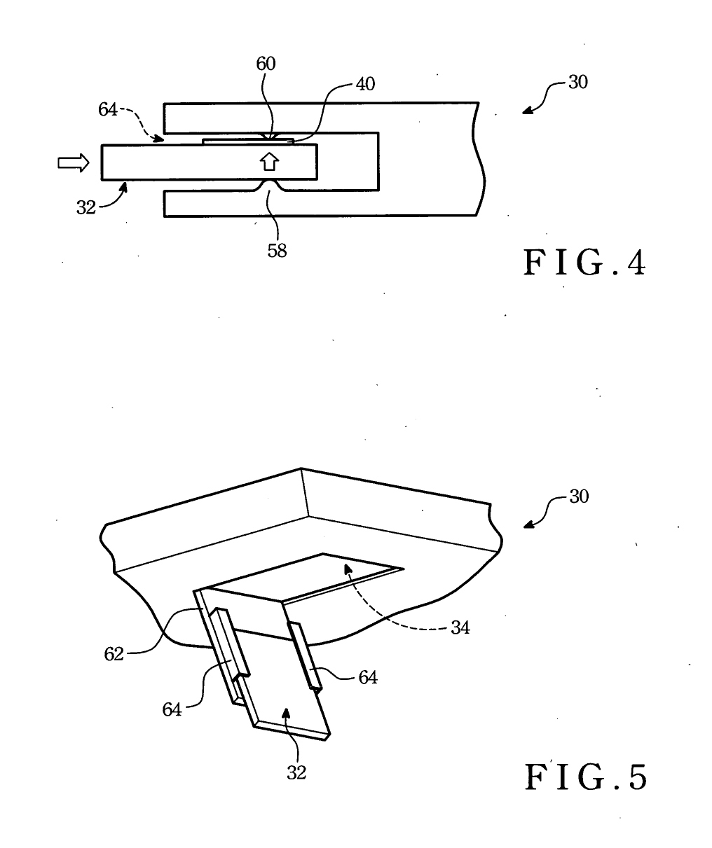

Referring to FIG. 4, the electronic communication device 30 further has a lifting member 58 located therein under the housing structure 32 in contact with one lateral side thereof opposing the SIM holding bracket 324. While the housing structure 32 is inserted into the electronic communication device 30, the lifting member 58 raises the housing structure 32 to make the electric contacts 48 of the SIM card 40 to be in contact with electric contacts 60 of the electronic communication device 30 to establish electric connection.

Refer to FIG.5 for another embodiment of the housing structure 32 coupling with the electronic communication device 30. The electronic communication device 30 has a holding means 62 and an opening 34 on one surface which has one edge pivotally coupled with one side of the holding means 62. The holding means 62 has two guiding channels 64 on two sides to allow the housing structure 32 to slide in. After the holding means 62 is loaded into the electronic communication device 30, the SIM card 40 and the flash memory card 42 establish electric connection with the electronic communication device 30.

For unloading and loading the housing structure 32 into the electronic communication device 30, flip and unlatch the holding means 62 from the opening 34 of the electronic communication device 30, the housing structure 32 may be removed from or inserted into the holding means 62. Then the holding means 62 may be flipped and engaged with the opening 34 again.

Thus the electronic communication device 30 adopted the housing structure 32 of the invention can hold a SIM card 40 and a flash memory card 42 at the same time to save space of positioning and electric connection, and the housing structure also provides the benefit of carrying the SIM card 40 and the flash memory card 42 at the same time.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A housing structure for holding a SIM card and a flash memory card located in an electronic communication device having two opposite sides mating two opposing guiding channels of the electronic communication device for loading and unloading the housing structure in the electronic communication device, comprising:
a SIM card holding bracket for holding the SIM card to make electric contacts thereof to face an outer side of the housing structure to establish electric connection with the electronic communication device; and
a flash memory card holding bracket having one lateral surface abutting an inner side of the SIM card holding bracket and an opening on one side to receive the flash memory card into the housing structure and establish electric connection with the electronic communication device.

2. The housing structure of claim 1, wherein the SIM card holding bracket and the flash memory card holding bracket are made from a same material in an integrated manner.

3. The housing structure of claim 1, wherein the electronic communication device further includes an unloading means to unload the housing structure, the unloading means including:
a push rod located on the electronic communication device abutting one side of the housing structure and movable back and forth having one end exposed outside the electronic communication device;
a linkage bar located on another side of the housing structure opposing the opening having one end pivotally connected to other end of the push rod;
a fulcrum fixedly located on the electronic communication device between two ends of the linkage bar to couple the linkage bar on the electronic communication device; and
an unloading member located on other end of the linkage bar;
wherein the push rod is moved towards the electronic communication device when subject to an external force to generate a levering action about the fulcrum to allow the unloading member to push the another side of the housing structure opposing the opening to push the housing structure outside the electronic communication device.

4. The housing structure of claim 3 further having a lifting member located in the electronic communication device in contact with one lateral side of the housing structure opposing the SIM holding bracket to raise the housing structure while loading into the electronic communication device to form electric connection between the SIM card and the electronic communication device.

5. The housing structure of claim 1 further having a holding means, the electronic communication device having an opening on one surface which has an edge pivotally coupled with one side of the holding means, the holding means having two, guiding channels on two sides for loading and unloading the housing structure, the SIM card and the flash memory card and the electronic communication device forming electric connection when the holding means is loaded into the electronic communication device.

6. The housing structure of claim 1, wherein the SIM card holding bracket has two opposite sides each having an elastic clip to clamp and hold the loaded SIM card.

7. The housing structure of claim 1, wherein the flash memory card is a Secure Digital card.
